(19) United States
(12) Patent Application Publication
(10) Pub. No.: US 2020/0183862 A1
(43) Pub. Date: Jun. 11, 2020

(54) DATA STORAGE MODULE AND SYSTEM HOST HAVING THE SAME

(71) Applicant: Super Micro Computer Inc., San Jose, CA (US)

(72) Inventors: Yueh-Ming LIU, San Jose, CA (US); Hung-Chieh CHANG, San Jose, CA (US); Tan-Hsin CHANG, San Jose, CA (US); Hsiao-Chung CHEN, San Jose, CA (US); Chih-Wei CHEN, San Jose, CA (US)

(21) Appl. No.: 16/215,663

(22) Filed: Dec. 11, 2018

(51) Int. Cl. G06F 13/16; G06F 13/42

(52) U.S. Cl. CPC G06F 13/1668; G06F 2213/0032; G06F 2213/0028; G06F 13/4282

(57) ABSTRACT

A data storage module includes an adapter and at least two data storage units. The adapter includes a hybrid port and at least two transmit ports coupled to the hybrid port, and the hybrid port is a hybrid U.2 transmission interface compatible with transmission protocols of SATA, SAS, and NVMe. Each of the data storage units has a transmission protocol different from that of other data storage units and coupling one of the compatible transmit ports according to a defined transmission protocol. A system host communicates for data storage or data access with each of the data storage units through the hybrid port and each of the transmit ports correspondingly coupled to each of the data storage units in the meantime.

### BACKGROUND

### Technical Field

The present disclosure relates to a data storage module, and more particularly to a data storage module having an adapter with a hybrid port.

### Description of Related Art

The statements in this section merely provide background information related to the present disclosure and do not necessarily constitute prior art.

With the development of storage media, the most popular development is the non-volatile storage device that uses flash memory to store data, such as solid-state drive (SSD), etc. Because SSD is not like the traditional hard disk drive (HDD) which contains components that spin with high speed during operation, SSD not only consumes less power, but also has better tolerance to environmental variability than the traditional hard disk drive. The flash memory has advantages of higher impact resistance, lower access time, and more flexible space configuration. In addition, the solid-state drive or the flash memory is designed to be smaller and thinner than the HDD. Actually, if the requirements of higher access speed and performance are considered by the user, the best way is to select a storage device compatible with the NVMe transmission protocol. However, this will require a higher cost, and also limits the scalability and flexibility of storage devices of the system host.

Therefore, how to design a data storage module to solve the above technical problems is an important subject studied by the inventors and proposed in the present disclosure.

### SUMMARY

The objective of the present disclosure is to provide a data storage module. With proper configuration, a system host may access data storage units of two different transport protocols so that the system host is no longer limited to use only one type of data storage unit.

In order to achieve the foregoing objective, the data storage module includes an adapter and at least two data storage units. The adapter includes a hybrid port and at least two transmit ports coupled to the hybrid port. The hybrid port is a hybrid U.2 transmission interface compatible with transmission protocols of SATA, SAS, and NVMe. Each of the data storage units has a different transmission protocol couples one of the compatible transmit ports according to the corresponding transmission protocol. A system host simultaneously communicates for data storage or data access with each of the data storage units through the hybrid port and each of the transmit ports.

Another objective of the present disclosure is to provide a system host. The system host increases the number of data storage units with different transmission protocols to achieve better storage data expansion under the same number of connectors on the backplane.

In order to achieve the foregoing another objective, the system host includes a computing unit, a backplane, and at least one data storage module. The backplane is electrically connected to the computing unit, and the backplane has a plurality of connectors. Each of the connectors is a hybrid U.2 transmission interface compatible with transmission protocols of SATA, SAS, and NVMe. The data storage module includes an adapter and at least two data storage units. The adapter includes a hybrid port coupled to one of the connectors and at least two transmit ports coupled to the hybrid port. The hybrid port is a hybrid U.2 transmission interface compatible with transmission protocols of SATA, SAS, and NVMe. Each of the data storage units has a different transmission protocol couples one of the transmit ports according to the corresponding transmission protocol. The computing unit simultaneously communicates for data storage or data access with each of the data storage units of the data storage module through the hybrid port and each of the transmit ports.

During operation of the data storage module of the present disclosure, the system host simultaneously communicates with the two data storage units in the data storage module through the adapter. Therefore, the system host has an expansion function, which may meet the storage capacity and the access speed according to the use requirements. It also solves the problem of taking much labor and time when the system host has to test the data storage units with two different transport protocols simultaneously. It even solves other non-simultaneous environmental factors and other issues, and achieves the objective of improving the costs control of related operators.

### BRIEF DESCRIPTION OF DRAWING

FIG. 1 is a schematic block diagram of a data storage module according to the present disclosure,

FIG. 2 is a schematic diagram of storage operation of the data storage module according to the present disclosure,

FIG. 3 is a schematic diagram of reading operation of the data storage module according to the present disclosure,

FIG. 4 is a structural diagram of the data storage module according to the present disclosure, and

FIG. 5 is a schematic block diagram of a system host according to the present disclosure.

### DETAILED DESCRIPTION

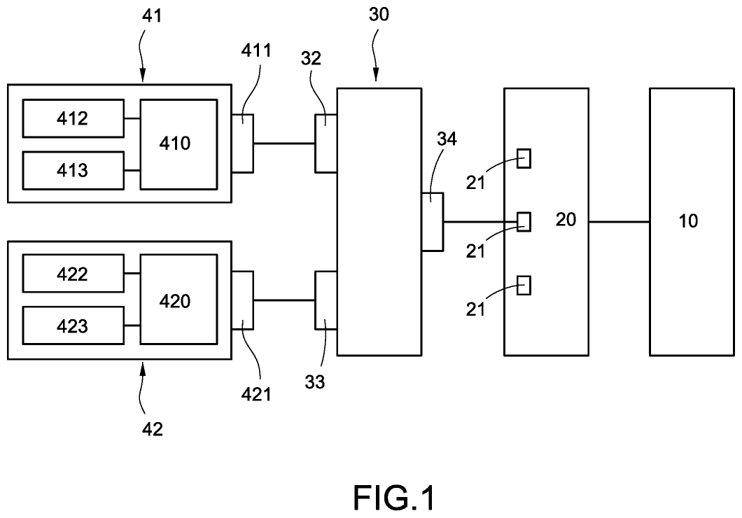

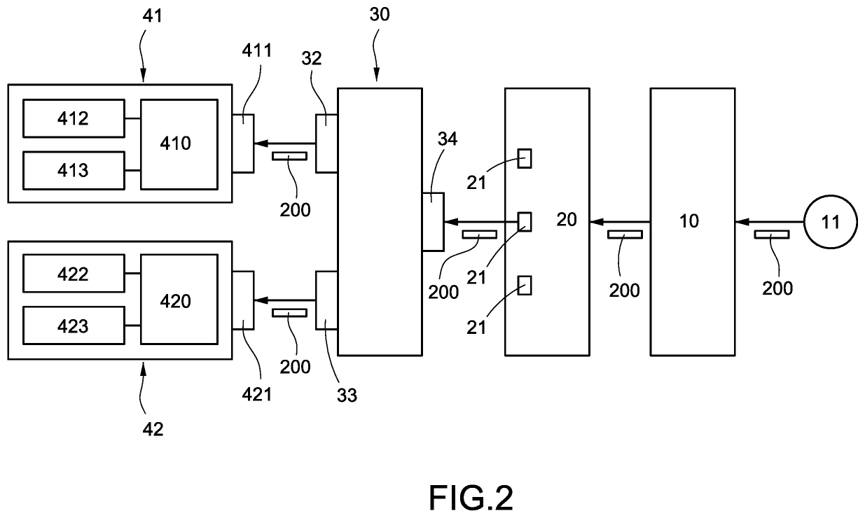

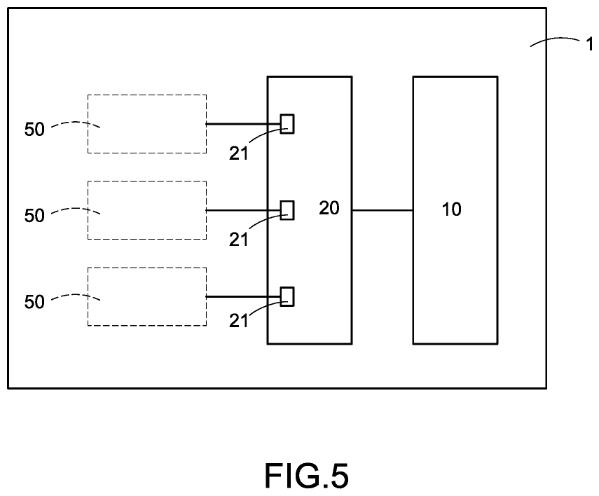

Please refer to FIG. 1, FIG. 2, and FIG. 5, FIG. 1 is a schematic block diagram of a data storage module according to the present disclosure, FIG. 2 is a schematic diagram of storage operation of the data storage module according to the present disclosure, and FIG. 5 is a schematic block diagram of a system host according to the present disclosure.

In one embodiment of the data storage module 50 of the present disclosure, an adapter 30 and two data storage units 41, 42 are included. However, the number of the data storage units described in the present disclosure is not limited to that above.

The adapter 30 includes a hybrid port 34 and at least two transmit ports 32, 33 coupled to the hybrid port 34, and each of the transmit ports 32, 33 may be different transmission interfaces or the same transmission interface. In particular, the transmission interface in this embodiment refers to a connector specification or a transmission standard. If the transmit ports 32, 33 are different transmission interfaces, which means that the transmit ports 32, 33 are different transmission standards, for example, the transmit port 32 may be a SAS transmission interface, and the transmit port 33 may be a PCIe transmission interface. If the transmit ports 32, 33 are the same transmission interface, the transmit ports 32, 33 may be both M.2 transmission interfaces, and are not particularly limited herein.

Each of the transmit ports 32, 33 may be selected to be compatible with different transmission interfaces such as SATA, PCIe, mSATA, mPCIe, M.2, M.3, U.2, NF1, NGSFF or EDSFF depending on the usage requirements. The hybrid port 34 has compatibility with at least two types of transmission interfaces. In a preferred embodiment, the hybrid port 34 may be a hybrid U.2 transmission interface compatible with three transmission protocols of SATA, SAS, and NVMe. Each of the data storage units 41, 42 has a transmission protocol different from that of the other, and each of the data storage units 41, 42 is coupled to one of the transmit ports 32, 33 of the compatible transmission interfaces in accordance with the defined transmission protocol.

The computing unit 10 in the system host 1 may simultaneously communicate for data storage or data access with each of the data storage units 41, 42 in each of the data storage modules 50 through the hybrid port 34 and each of the transmit ports 32, 33 correspondingly coupled to each of the data storage units 41, 42.

Specifically, the communication referred to in this embodiment means that the computing unit 10, for example but not limited to a CPU, is electrically connected to and communicated with the controllers 410, 420 of the data storage units 41, 42. In other embodiments, the communication with the data storage units 41, 42 may be performed by the computing unit 10 of the local location by transmitting the execution command from an external system host 11 at other external locations through a local network or an Ethernet connection.

Further, if the system host 1 is a server having a backplane 20, the hybrid port 34 is coupled to one of connectors 21 of the backplane 20 and further coupled to the computing unit 10 via the connector 21. The backplane 20 may be a single-sided backplane or a double-sided midplane, which is compatible with general-purpose high-speed backplane architecture standards, such as CPCI, ATCA, MicroTCA, VPX, etc.

In addition, in other embodiments, the backplane 20 may be replaced with other motherboards or electronic circuit boards having the connectors 21 with same transmission function, and the computing unit 10 may be selectively disposed on the motherboard or the electronic circuit board. In the embodiment of the present disclosure, the backplane 20 may provide a hot-swapping function to the hybrid port 34 and the connector 21 may be a connector with a U.2 transmission interface.

Further, each of the data storage units 41, 42 includes a connection end 411, 421, a controller 410, 420, and a non-volatile memory 412, 422 coupled to the controller 410, 420 and a cache unit 413, 423 coupled to the controller 410, 420. The connection ends 411, 421 are compatible with at least one transmission interface of SATA, PCIe, mSATA, mPCIe, M.2, M.3, U.2, NF1, NGSFF, and EDSFF. Each controller 410, 420 is compatible with at least one transmission standard of the NVMe, SAS, and SATA. The non-volatile memory 412, 422 may be a NAND Flash, and the cache unit 413, 423 may be a volatile memory. In other words, the data originally stored in the cache units 413, 423 would be eliminated when the operating power is lost.

Please refer to FIG. 2, which is a schematic diagram of storage operation of the data storage module according to the present disclosure. When the computing unit 10 stores the data 200 into the data storage units 41, 42, the computing unit 10 transmits the data 200 to the controllers 410, 420 via the backplane 20 and the adapter 30, and the controllers 410, 420 temporarily store the data 200 into the cache unit 413, 423, and then the data 200 are gradually written into the non-volatile memory 412, 422 according to the firmware procedure within the controllers 410, 420. Thus, the data 200 would not be lost when the system host 1 is shut down.

Further, in different embodiments, the external system host 11 may communicate with the computing unit 10, and then the computing unit 10 may perform the storage operation of the data 200.

In addition, the system host 1 with the computing unit 10 and the external system host 11 may be a server, a personal computer (PC) or a notebook computer (NB), a tablet computer, a smart phone, a personal digital assistant (PDA), and the other devices with the computing unit 10. In this embodiment, the backplane 20 is disposed inside the system host 1, and the adapter 30 and the data storage units 41, 42 coupled to the adapter 30 are also installed inside the system host 1.

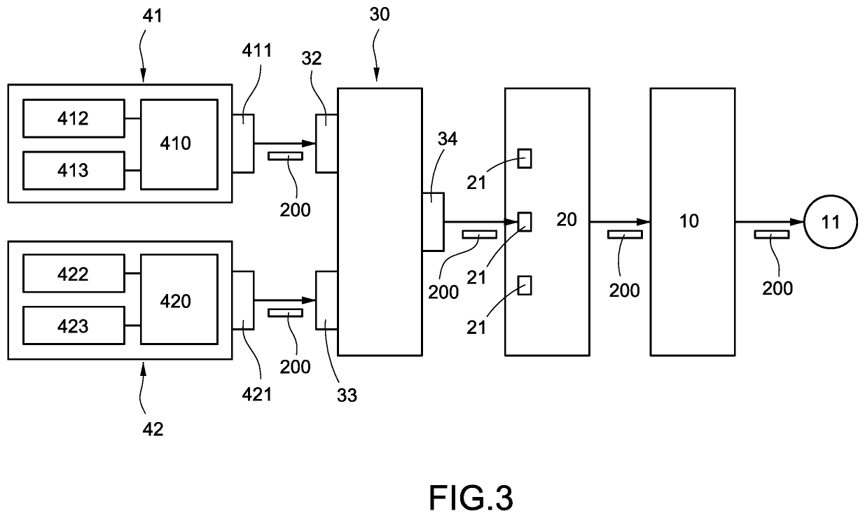

Please refer to FIG. 3, which is a schematic diagram of reading operation of the data storage module according to the present disclosure. When the computing unit 10 would like to read the data 200 from the data storage units 41, 42, the computing unit 10 communicates with the controllers 410, 420 through the backplane 20 and the adapter 30. The controllers 410, 420 read and temporarily store the data 200 from the non-volatile memory 412, 422 into the cache units 413, 423, and then transmit the data 200 for the reading operation by the computing unit 10.

If the user needs to perform the storage or reading test on the data storage units 41, 42 with two different transmission interfaces at the same time, the computing unit 10 may simultaneously communicate with the data storage units 41, 42 so as to perform the storage or reading operation on the data storage units 41, 42. More specifically, the computing unit 10 simultaneously communicates with the controllers 410, 420 of the data storage units 41, 42 for the storage or reading operations, thereby saving test time.

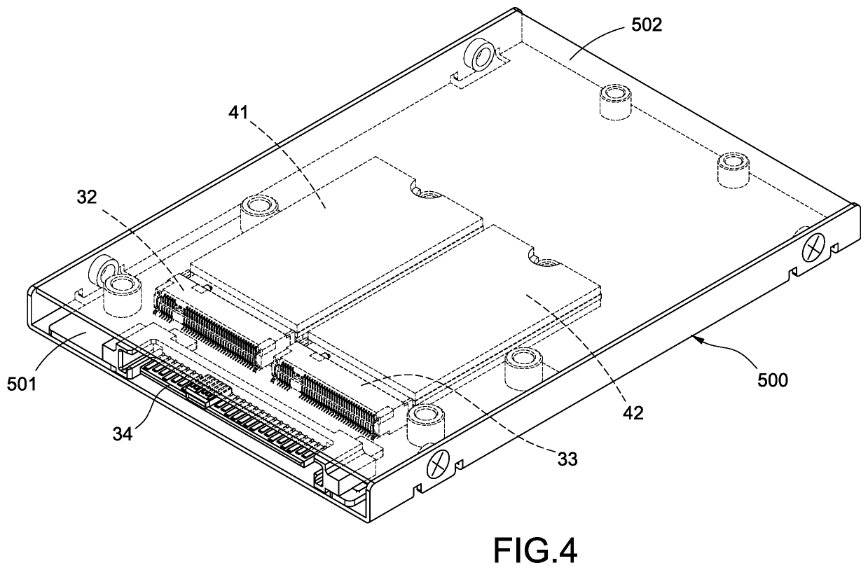

Please refer to FIG. 4, which is a structural diagram of the data storage module according to the present disclosure. In the embodiment of the present disclosure, the data storage module 50 further includes a substrate 501, a tray 500 and an upper cover 502. The adapter 30 and at least two data storage units 41, 42 are disposed on one surface of the substrate 501, and the hybrid port 34 is formed at one side of the adapter 30 and faces the outside of the substrate 501. The at least two transmit ports 32, 33 are formed at the other side of the adapter 30 and face the inside (opposite to the outside) of the substrate 501 to couple the at least two data storage units 41, 42. The at least two transmit ports 32, 33 are arranged side by side in a lateral direction such that the data storage units 41, 42 are arranged side by side.

The tray 500 and the upper cover 502 sandwich the substrate 501 therein and cover the adapter 30 and the at least two transmit ports 32, 33 so that the substrate 501 may be attached on the tray 500. The tray 500 and the upper cover 502 meet the 2.5″ hard disk specification. The data storage units 41, 42 may be solid state storage devices (SSD).

Referring to FIG. 1 and FIG. 5, the system host 1 includes the computing unit 10, the backplane 20, and a plurality of data storage modules 50. The backplane 20 has a plurality of connectors 21. Each data storage module 50 includes the adapter 30 and the data storage units 41, 42 coupled to the adapter 30, wherein each adapter 30 includes the hybrid port 34 coupled to one of the connectors 21 and at least two transmit ports 32, 33 coupled to the hybrid port 34. The computing unit 10 may simultaneously communicate with each of the data storage units 41, 42 of the data storage modules 50 for data storage or data reading through the hybrid port 34 of the adapter 30 and each of the transmit ports 32, 33 correspondingly coupled to each of the data storage units 41, 42. Therefore, the system host 1 may achieve the double-storage expansion effect in the case that the backplane 20 has the same number of the connectors 21. In other embodiments, only at least one data storage module 50 may be used to couple the backplane 20, that is, the number of the data storage modules 50 would be adjusted according to user's requirements.

Further, if the requirements of performance and storage space are considered by the user, one of the data storage units 41, 42 may be selected as a solid-state drive (SSD) that is compatible with the SAS or SATA transmission protocol or a hard disk drive (HDD). The other of the data storage units 41, 42 may be selected as a solid-state drive (SSD) that is compatible with the NVMe transmission protocol. Thus, the system host 1 can provide better access speed and more suitable manufacturing costs.

The above is only a detailed description and drawings of the preferred embodiments of the present disclosure, but the features of the present disclosure are not limited thereto, and are not intended to limit the present disclosure. All the scope of the present disclosure shall be subject to the scope of the following claims. The embodiments of the spirit of the present disclosure and its similar variations are intended to be included in the scope of the present disclosure. Any variation or modification that may be easily conceived by those skilled in the art in the field of the present disclosure may be covered by the following claims.

1. A data storage module comprising:
an adapter comprising a hybrid port and at least two transmit ports coupled to the hybrid port, the hybrid port being a hybrid U.2 transmission interface compatible with transmission protocols of SATA, SAS, and NVMe, and
at least two data storage units having two transmission protocols respectively, each of the data storage units coupling one of the transmit ports according to one of the corresponding two transmission protocols,
wherein a system host is configured to simultaneously communicate for data storage or data access with each of the data storage units through the hybrid port and each of the transmit ports.

2. The data storage module in claim 1, wherein the adapter comprises a substrate, the hybrid port and the at least two transmit ports are disposed on one side of the substrate, the hybrid port faces an outside of the substrate, the at least two transmit ports face an inner side of the hybrid port and facing thc substrate to couple the at least two data storage units.

3. The data storage module in claim 1, wherein the at least two transmit ports are arranged side by side in a lateral direction.

4. The data storage module in claim 2, further comprising a tray and an upper cover, the tray and the upper cover configured to sandwich the substrate and cover the adapter and the at least two data storage units so that the substrate is attached on the tray, wherein the tray and the upper cover meet a 2.5″ hard disk specification.

5. The data storage module in claim 1, wherein each of the data storage units comprises a controller, a non-volatile memory coupled to the controller, and a cache unit coupled to the controller.

6. The data storage module in claim 1, wherein each of the transmit ports is compatible with at least one transmission interface of SAS, SATA, PCIe, mSATA, mPCIe, M.2, M.3, U.2, NF1, NGSFF, and EDSFF.

7. The data storage module in claim 5, wherein each of the controllers is compatible with at least one transmission interface of SAS, SATA, and NVMe.

8. A system host comprising:
a computing unit,
a backplane electrically connected to the computing unit, the backplane having a plurality of connectors, each of the connectors being a hybrid U.2 transmission interface compatible with transmission protocols of SATA, SAS, and NVMe, and
at least one data storage module comprising:
an adapter comprising a hybrid port coupled to one of the connectors and at least two transmit ports coupled to the hybrid port, the hybrid port being a hybrid U.2 transmission interface compatible with transmission protocols of SATA, SAS, and NVMe, and
at least two data storage units having two transmission protocols respectively, each of the data storage units coupling one of the transmit ports according to one of the corresponding two transmission protocols,
wherein the computing unit is configured to simultaneously communicate for data storage or data access with each of the data storage units of the data storage module through the hybrid port and each of the transmit ports.

9. The system host in claim 8, wherein each of the data storage units comprises a controller, a non-volatile memory coupled to the controller, and a cache unit coupled to the controller.

10. The system host in claim 9, wherein each of the transmit ports is compatible with at least one transmission interface of SAS, SATA, PCIe, mSATA, mPCIe, M.2, M.3, U.2, NF1, NGSFF, and EDSFF.
